(19) United States
(12) Patent Application Publication
(10) Pub. No.: US 2019/0364340 A1
(43) Pub. Date: Nov. 28, 2019

(54) Brand and Ad Messaging Recall Method and System

(71) Applicant: ZEDO, Inc., New York, NY (US)

(72) Inventor: Roy de Souza, New York, NY (US)

(21) Appl. No.: 16/422,851

(22) Filed: May 24, 2019

Related U.S. Application Data
(60) Provisional application No. 62/676,020, filed on May 24, 2018.

(51) Int. Cl. H04N 21/475; H04N 21/81; H04N 21/44; H04N 21/4784; H04N 21/442; G06Q 30/02

(52) U.S. Cl. CPC H04N 21/4758; H04N 21/812; G06Q 30/0277; H04N 21/4784; H04N 21/44218; H04N 21/44016

(57) ABSTRACT

A video ad or video message is played for a viewer. After the video has played, it is removed from the screen or display and the viewer is presented with a quiz about the message sent by the video ad. The quiz is generally easy to answer but is done by the viewer after the video ad, the name of the company or brand, or any other information is removed from the screen. The format of the quiz can take one of a variety of formats, all generally enjoyable to the viewer and easy for the viewer to respond to. If answered correctly, a benefit relevant to the activity the user was engaged in inures to the viewer. The advertiser has successfully imparted a message to the viewer, the message relating to the brand, a specific product or server, the company and the like.

### CROSS-REFERENCE TO RELATED APPLICATIONS

This application claims priority under 35 U.S.C. § 119(e) to U.S. Provisional Patent Application No. 62/676,020 filed May 24, 2018, entitled “SMARTPHONE BRAND-RECALLS” which is incorporated by reference in its entirety for all purposes.

### BACKGROUND

### 1. Field

This disclosure generally relates to software and hardware for video ads and interacting with viewers of such ads. More specifically, it relates to methods of providing a user interface and user experience for delivering an ad message to viewers.

### 2. Description of the Related Art

Mobile games and premium content applications today offer premium content such as coins, credits or additional lives in return for viewing a short video clip called rewarded video.

Typically, the completion rates of rewarded videos are quite high and about 80%-90% of gamers choose the video ad option—the whole full 30 second video ads. However, the high completion rates don't often translate into high engagement rates for the advertisers because while the ad plays away on the screen most gamers either carry out some other task or just put the phone down or ignore the video. Consequently, many advertisers do not spend heavily on rewarded video.

It would be preferable to have a user interface and experience where it can be shown that a viewer of an ad actually recalls or remembers the message of the ad by interacting with the advertiser and having a way of measuring how effective the video ad is in conveying the message to the viewer.

### SUMMARY

Rewarded videos have a high reach but engagement needs to be improved. App owners (app developers or publishers) want to earn more advertising revenue. This means that advertisers need to pay higher rates or buy more advertising; and that will only happen when advertisers are more confident that user are paying attention to their video ads.

In some embodiments of the present invention, experiences are created where a viewer has to watch the video and engage with it to earn their reward. We modify the user's experience with the video ad (make the ad experience more interactive)—something that the user watches and engages with. And because viewers have to engage with the video that means they watched it and absorbed the message that the advertiser is sending.

The engagement may be as simple as asking the viewer to choose the car he likes or type in the name of the advertiser. To the user it feels like an easy quiz or a game. Further, getting the viewer to type in the brand name is perhaps the best way of building advertiser recall as the brand name or advertiser name is repeatedly registered in the viewer's mind. To maintain the viewer's attention without creating frustration the manner in which the user is asked to interact with the video ad is like a quiz or game.

In accordance with an exemplary embodiment, the following are the key modules which create the User Experience as explained below and as shown in FIG. 1.

Viewer reaches a point in the game where he can choose to watch the rewarded video to continue playing the game with his existing score or to get a free life or more coins.

Viewer is prompted to watch the video to get this reward. We present it as a quiz: user watches because he/she will then be asked a simple question about the video.

At the end of the video, we ask the user a simple quiz/question, for e.g. “What is the name of the brand?” The user can easily answer the question if he has seen the video advertisement and hence types the answer to get his/her reward.

If the answer is correct, user has the choice to either take the reward and continue with the game or take the reward and visit the advertiser's website. So the user is happy with the trade-off and has a positive feeling towards the video ads in the game.

Why does the user have to type the answer? As typing or writing an answer is more effective than selecting some options. The user is likely to remember the brand better if he/she types the answer. If a user is ready to type the answer, we know that he/she has paid some attention to the ad. Further just by the act of typing (or engaging in another way) the user is thinking about the brand. His brain is processing the name and thinking about it. The viewer's brain will then remember this brand much more than if user had not typed the brand name. However we also have options where the user chooses the correct answer from a multiple choice format.

The Watch and Engage ad format has an innovative edge over regular rewarded videos as it ensures that the user is actually watching the screen and gets user engagement with the advertiser's video. This gives the advertisers a more cost-efficient way to advertise.

The Watch and Engage ad format can be compliant with all known advertising standards. This format adds a new dimension to Rewarded video formats thus empowering publishers to increase their revenue and helps advertisers with high-impact engaging video advertising that is actually seen by the user.

One aspect of the invention is a method that initiates with the playing of a video ad or video message intended for a viewer on a screen. After the video has finished playing or at some point while the video is still playing (the video may not have to end), the video and all information about the company, brand, message, and the like are removed from the screen. Content is then presented to the viewer, this content referred to generally as a quiz about the message sent by the video ad. The quiz can take one or more of various formats. Once the viewer answers the quiz correctly, a benefit relevant to the activity inures to the viewer. Whether or not the viewer answers correctly the first time, the advertiser (or a related entity on behalf of the advertiser) is able to interact with the viewer in a way that is most effective in sending a message relating to the brand or company to the viewer. As described, there is a sequential characteristic to the user (viewer) interface that makes the process of impressing an advertising message on the viewer more effective and from which actual statistics can be derived.

### BRIEF DESCRIPTION OF THE DRAWINGS

FIG. 1 is a block diagram showing a mobile phone and key modules which create a user experience for brand and messaging recall in accordance with one embodiment;

FIG. 2 is a series of screen shots which illustrate steps a user takes to experience the advertising techniques disclosed in accordance with one embodiment;

FIG. 3 is a flow diagram showing a process of downloading an app to displaying a video ad and answering a quiz in accordance with one embodiment;

FIG. 4 is a flow diagram of a process of displaying ad content on a device in accordance with one embodiment;

FIG. 5 is a caching engine and a device and the flow of data across its services in accordance with one embodiment;

FIGS. 6A to 6F are screen shots showing various formats of quizzes presented to a viewer for message or brand recall in accordance with one embodiment; and

FIG. 7 is a block diagram of a computing device in accordance with one embodiment.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting. On the contrary, it is intended to cover alternatives, modifications, and equivalents as may be included within the spirit and scope of the described embodiments as defined by the appended claims.

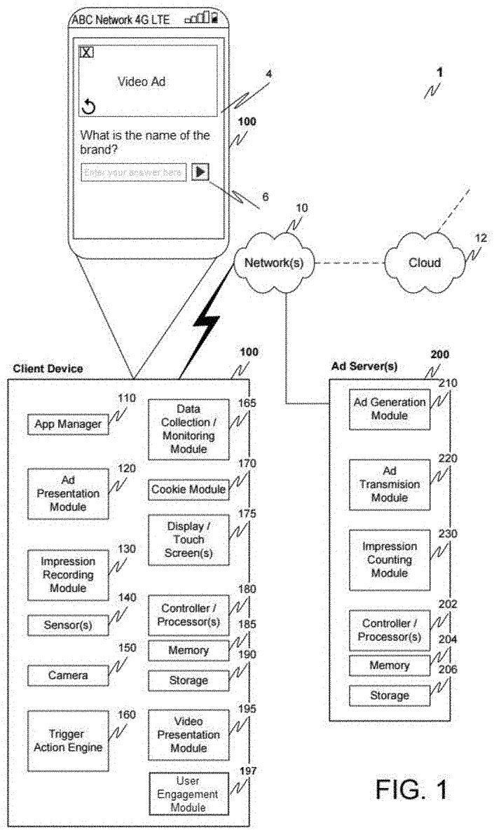

FIG. 1 illustrates an exemplary content providing environment 1. The content providing environment 1 includes a client device 100, and ad server 200, one or more networks 10 and one or more clouds 12. An exemplary embodiment of the ad server 200 comprises an ad generation module 210, an ad transmission module 220, an impression counting module 230, controller/processor 202, memory 204, storage 206, as well as conventional and well known componentry. While the following description will be discussed in relation to ads, it is to be appreciated as discussed above that the ad server 200 can provide any type(s) of content.

An exemplary embodiment of the client device 100 includes an app (application) manager 110, an ad presentation module 120, an impression recording module 130, one or more sensors 140, a camera 150, a smart trigger action engine 160, a data collection/monitoring module 165, a cookie module 170, one or more displays/touch screens 175, controller/processor 180, memory 185, storage 190, a video presentation module 195 and a user engagement module 197. As discussed an exemplary embodiment will be discussed in relation to an embodiment where the client device 100 is a smartphone, however, the client device can in general be any device capable of displaying content in the manner described herein.

To begin, and in accordance with an exemplary operational embodiment, a user downloads an application from, for example, an app developer and/or an ad server in cooperation with the app manager 110. Typically there are two options for downloading of an application: 1) download for free—with the understanding that the user may receive advertisements form, for example, one or more sponsors, or 2) pay a fee, such as a one-time or recurring fee for the use of the application. Generally, but not always, the payment of the fee reduces or eliminates the advertisements the application downloader will receive.

Generally, if the application is downloaded or provided for free, the user, i.e., the application downloader, will need to opt in to confirm that it is acceptable for the user to receive ads as a condition to being provided the application for free. In accordance with one exemplary embodiment, a second or double opt-in process is provided to confirm the opt-in, such as through an email confirmation message.

Upon opting in, the app controls decides if it wants to show an ad to a user. If yes, it invokes the Trigger action engine 160 which with coordination from the Ad transmission module 220 pre-caches the ad. The trigger action engine 160 is invoked when the required user action is performed on the app which indicates that the app is now ready to receive an ad from the ad presentation module 120 and from the ad transmission module 220.

For example, and in accordance with one exemplary embodiment, the trigger action engine 160 is invoked after completion of an event/action, such as a user clicks on a button to add 1 more life after exhausting the life's available to continue playing a game or by completing some other task on the device 100. This completing of an event has been determined to be one example when the app is ready to receive an ad from the ad presentation module 120.

Once a triggering event has occurred the app invokes the trigger action engine 160, in accordance with one exemplary embodiment, a pre-cached advertisement is downloaded from one or more of the cloud 12 and ad server(s) 200 and stored in storage 190 and/or memory 185, and is presented in cooperation with the video presentation module 195. The Ad presentation module 120 and Ad transmission module 220 can also pass the relevant question to be asked to the user at the end of the ad to the user engagement Module 197. The user engagement module will then display additional overlay text that alerts the user about the questions and presents the question at the end of the video, as shown on the device 100 in FIG. 1. Here, in this exemplary embodiment, a video 4 has played and ended and the question 6 is presented on the device. While not required, one exemplary advantage to having a pre-cached ad is that the user experience can be improved in that the ad, especially if it is video, is smooth and seamless. This pre-caching can commence after the application is loaded and the application invokes the trigger action engine 160, and is not limited to video, but in general any content that will be presented to a user in cooperation with the ad presentation module 120. Additionally or alternatively, and in conjunction with the presentation of an ad by the ad presentation module 102, one or more of the impression recording module 130 and impression counting module 230 can track the number of times the ad/content has been presented.

The user engagement module 197 will present the question as received from the ad presentation 120 and Ad transmission module 220 and compare the characters typed by the user to the correct answer received. If the characters match 50% of the characters in the correct answers, the answer is considered as correct and user is presented with a “Continue” or “Visit advertiser” button.

Upon presentation of the advertisement, additional actions can also occur such as turning on the sound to a predefined level, determining whether the device is in a portrait or landscape orientation and adjusting the advertisement accordingly. These preferences can be governed by the controller 180 in cooperation with, for example, one or more user preferences stored in storage 190 and/or one or more preferences associated with an app that was downloaded. For example, the app may recommend setting a volume level at 50% based on information from one or more sensors 140.

Moreover, the number of ads can be tracked/counted as discussed in accordance with one or more of the impression recording module 130 and impression counting module 230 such that the user is only presented with a certain number of ads in a given time frame. In the event the threshold number of ads has been reached for a given timeframe, even though a triggering event has been detected an ad may not presented until the counter is reset and/or the smart trigger action engine 160 determines another ad should be presented.

In addition to one exemplary embodiment where video content is generated by the ad generation module 210 and displayed on the device 100, additional information can also be presented as illustrated above. This additional content can include one or more of a headline, an article title, a snippet, a thumbnail, publisher branding (e.g., a logo, an additional branding message, etc.), link(s), and the like.

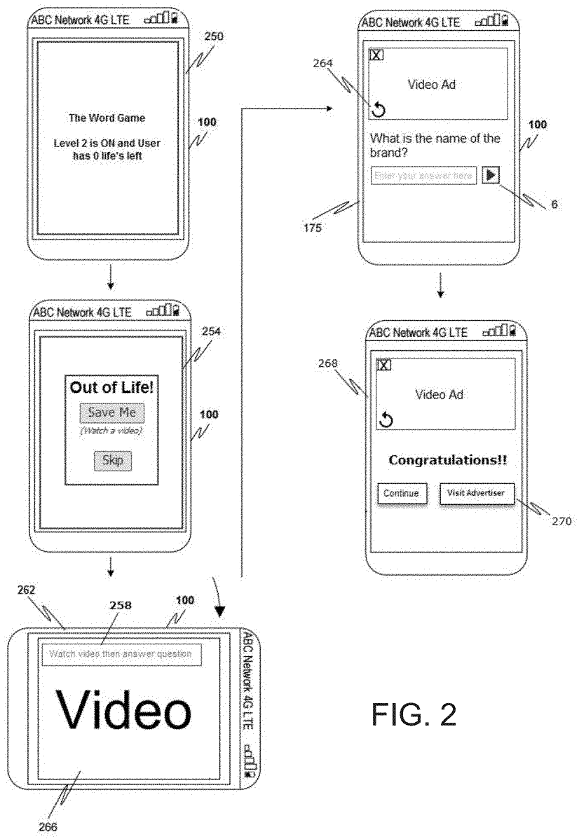

FIG. 2 shows exemplary screen captures which illustrate exemplary steps a user takes to experience an exemplary embodiment of the advertising techniques disclosed herein (here the user has already downloaded a game app, and opted in for the advertising, e.g., Watch & Engage Ad Format:

1) A user opens a game app and starts playing in device 100 as shown in 250.

2) The user has hit a dead end in the game and he cannot continue it as he/she has exhausted the maximum life's to continue the game. However, the app presents the user with another life after watching a video ad, as shown in step 254.

3) Users opts in and clicks on the “Save Me” button.

4) The trigger action engine 160 initiates auto-play of the ad in step 262 and serves the video ad 266 in landscape mode on display 175 (optionally with the sound on the device turned on/off/at a specified volume level).

5) As the video plays we display an overlay text 258 that alerts user about the question/quiz at the end of the video.

6) In step 264, The video ends and the video thumbnail 264 with a close and replay button is displayed on the top half of the screen 175 and the question 6 is presented below it to the user in landscape/portrait mode as per user preference.

7) In Step 268, The users have entered the correct answer and is presented with a button to “continue” playing the game and another to “Visit Advertiser” website as shown in point 270.

Some of the exemplary advantages associated with the techniques described herein are as follows:
The technology can provide an option to the advertisers to ask relevant question or other means of user engagement to enhance Brand building. User engagement ensures true views which are currently missing in a regular rewarded video.
The exemplary ad is pre-cached by Trigger action engine 160 when invoked by the app, this ensures we have and ad ready to play immediately after user action and the performance is smooth and seamless.
In accordance with one exemplary embodiment, the publisher app decides when to show the ad by invoking the trigger action engine 160, which pre-caches the ad and in case of no ad available will coordinate with the publisher app and will not give an option to add more life by watching a video.

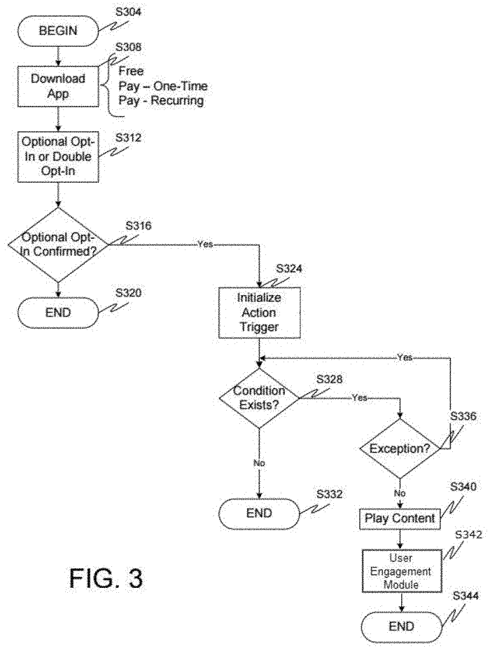

FIG. 3 outlines an exemplary method of operation of the systems described herein. Control begins in step S304 and continues to step S308. In step S308, an app(s) is downloaded. As discussed, the app can be free, or paid for such as one time or recurring. Next, in step S312, an opt-in or double opt-in is optionally performed. Then, in step S316, it is determined whether the opt-in or double opt-in was confirmed. If confirmed, control continues to step S324, with control otherwise continuing to step S320 where the control sequence ends.

In step S324, the trigger action engine is initialized by the Publisher application. As discussed, the trigger action engine pre caches the ad by fetching it from the ad presentation and ad transmission modules and further invokes delivery of the ad and user engagement question based on user event completion.

Next, in step S328, a determination is made whether a condition exists to cause display of the content/video. If a condition does exist, control continues to step S336, with control otherwise continuing to step S332 when the control sequence ends.

In step S336, a determination is made as to whether an exception exists where the video should not be presented. For example, if it is determined that a user is driving based, for example, on GPS information, this may be characterized as an exception condition where control continues back to step S320 and the content/video not played. Other exceptions may exist as well such as user preferences, publisher preferences, the ad/content has already been shown a predetermined number of times, the user is not holding or looking at the device 100, etc.

If an exception does not exist, control continues to step S340 where the content/video is presented with control continuing to step S342 the user engagement module, which presents the question which when answered the control is passed to S344 where the control sequence ends.

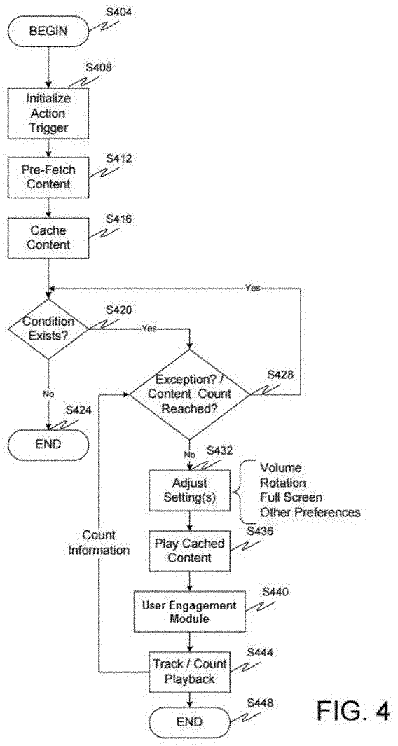

FIG. 4 outlines an exemplary method of presenting an ad/content on the device 100. In particular, control begins in step S404 and continues to step S408. In step S408, the trigger action engine is initialized. Next, in step S412, ad/content is pre-fetched from one or more of an ad server and the cloud. Next, in step S416, the ad/content is cached and stored in memory. Control then continues to step S420.

In step S420, a determination as to whether a condition exists that acts as a trigger for the smart trigger action engine to present the ad/content. If a condition does exist, control continues to step S428 with control otherwise continuing to step S424 where the control sequence ends.

In step S428, a determination is made as to whether an exception exists where the content/video should not be presented. For example, if it is determined that a user is driving based, for example, on GPS information, this may be characterized as an exception condition where control continues back to step S320 and the content/video not played. Other exceptions may exist as well such as user preferences, publisher preferences, the ad/content has already been shown a predetermined number of times, the user is not holding or looking at the device 100, etc. If an exception exists, control jumps back to step S420 with control otherwise continuing to step S432.

In step S432, one or more settings can be automatically or semi-automatically adjusted. For example, based on one or more user preferences, device settings and/or published preferences, one or more of volume, orientation, whether to display in full screen, or the like, can be adjusted. Next, in step S436, the cached content is displayed. In step S440, user engagement question will be displayed at the end of the video (See for example FIG. 1). Then, in step S444, an ad/content impression count is counted with control continuing to step S448 where the control sequence ends.

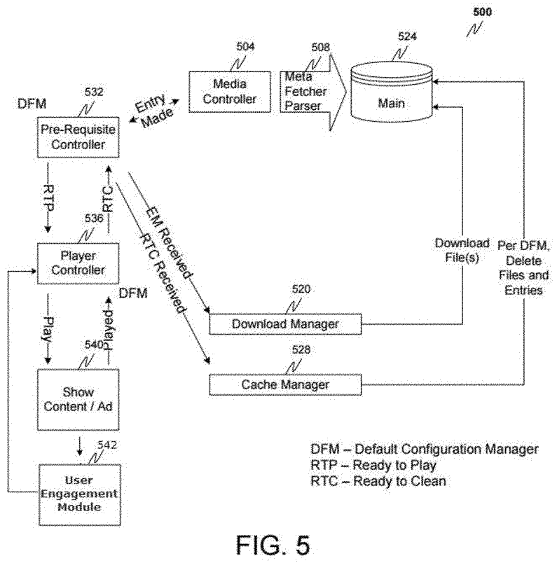

FIG. 5 illustrates and exemplary operational diagram for pre-caching media, with RSS (Really Simple Syndication) and cloud-sync for settings management.

In accordance with one exemplary embodiment, the Watch and Engage SDK (Software Development Kit) employs a clever pre-fetching and caching module that brings seamless media ad serving to its high impact ad unit. At the core lies a caching engine that commands multiple lightweight background services together ensuring comprehensive fill rates at all times. The caching engine is supplemented with a cloud based configuration manager which administers optimal settings at all times. This cloud based update manager allows default settings to be stored in the cloud while allowing frequent updates to be monitored and applied efficiently across devices that house the SDK implemented mobile application.

Pre-Caching Media files & RSS feeds FIG. 5 shows exemplary components housed inside the caching engine 500 and a device and the flow of data across its services. The caching engine 500 comprises multiple components: a media controller 504 which houses a meta-fetcher as well as the parser service 508. A download manager 520 downloads media files from a database 524. A cache manager 528 unifies the components and communicates with the main data store in database 524.

In operation, an entry is made (EM) with the media controller 504 to fetch/parse content from the data store 524. In conjunction with this operation, the RSS controller 512, in cooperation with the feeder/cleaner 516 retrieves information from the RSS database 544. The prerequisite controller 532 communicates to the download manager 520 that an EM has been received to present an ad/content, and the ad/content retrieved from the data store 524. Once downloaded, the pre-requisite controller 532 issues a ready to play instruction to the player controller 536 which in turn causes the presentation of the ad/content on player 540. Once played, the user engagement module is initialized which presents the question to the user. Once answered correctly, the player controller 536 issues a ready to clean instruction to the pre-requisite controller 532 which in turn issues a ready to clean instruction to the cache manager 528 that, in accordance with a default configuration manager, optionally deletes one or more files and entries from the data store 524.

These components, its services and their subsidiary modules can work in tandem and warrant an efficient service oriented architecture that is designed for speed even on lower specification devices and ensures that it has an extremely light imprint on the device's memory and CPU.

In an alternative embodiment, methods and systems for implementing a user interface and user experience of showing a quiz or short question about a video advertisement or video message to the viewer after the video ad or video message has completed or is off the screen is described in the various figures. After the video ad or video message has played and is off the screen, the viewer is asked to answer a short question about that video ad, also referred to herein as a quiz. The specific video ad, specific quiz, and other factors of the user experience and interface are pre-determined or pre-selected by the advertiser or by the company executing the advertising. Referring to FIG. 2, the viewer decides to watch a video ad or the video ad is simply played for the viewer without the viewer intentionally electing to watch it, this leads to answering a short quiz about the video after the video ad has played and is off the screen. As shown in the last two screen shots in FIG. 2, a final frame or first frame of the video ad may still be present and visible on the device screen when the question or quiz is presented to the viewer. It may also be shown when the viewer has answered the question. In the alternative embodiment described below, the user experience, user interface, and execution of the user engagement module is different from that described above.

Before describing the alternative embodiment, it is important to note that an advertiser often wants to impart more than simply its brand name or product name to a viewer through a video ad (or any other type of advertising or marketing). The advertiser may want to show a specific message to the viewer about their brand or about their product or service. And the advertiser may want to teach the viewer this message in such a way that the viewer thinks about it and recalls or remembers it. This message can take the form of a tag line, a phrase, an image, a graphic, an audio clip, a price, a special offer, or, a word that the advertiser wants the viewer to remember and to associate with its product, service or brand name. The advertiser may prefer to leave a specific message or impression about the company or brand; something more targeted and memorable that is associated with the brand. They would also prefer to have a degree of assurance or an indication that the message it is sending via the ad is at least minimally resonating or remembered by the viewer. As noted, the message may be embodied or conveyed in one word or more than one word. In this embodiment the advertiser may ask the user to type one word in a phrase with the aim of teaching the user to remember the whole phrase.

In an alternative embodiment, user engagement module 542 and other modules described above enable playback of the video ad, and when the video is complete, these modules enable certain operations described below. First, the video is not displayed (no beginning or ending frames) nor is any remnant textual or graphic information relating to the ad or the company, brand, etc. displayed on the screen. Second, quiz delivery software executes effectively immediately after the video is cleared from the screen. The quiz may be in one of several formats, such as re-arranging letters to form a word conveying the message, placing floating letters in order for the message, popping the right balloons with the right letters, speaking out the letters or a whole phrase, moving the phone to spell the letters, choosing one answer from multiple choices, and any other interface to allow the viewer to spell something about the message to indicate that they have watched the video ad previously shown.

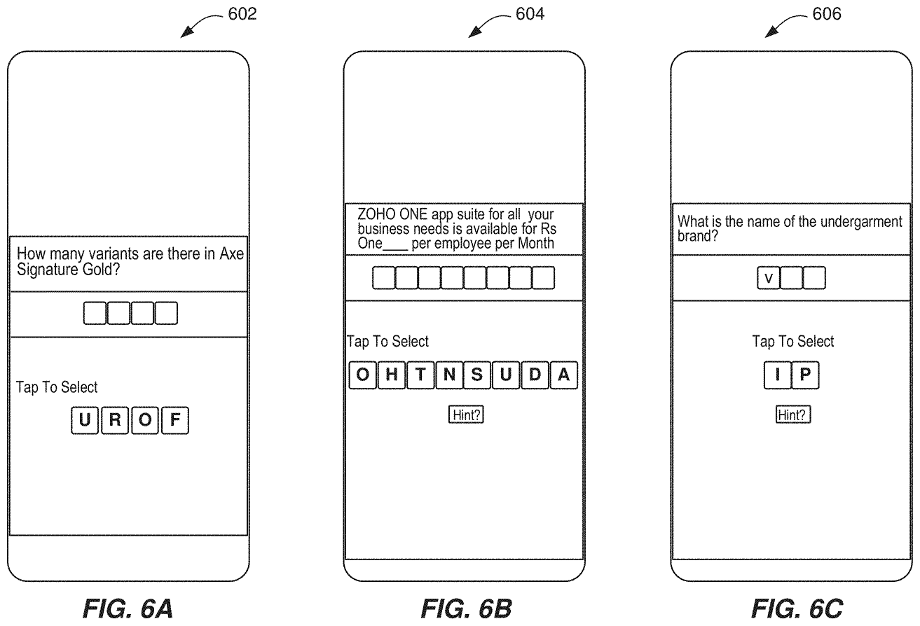

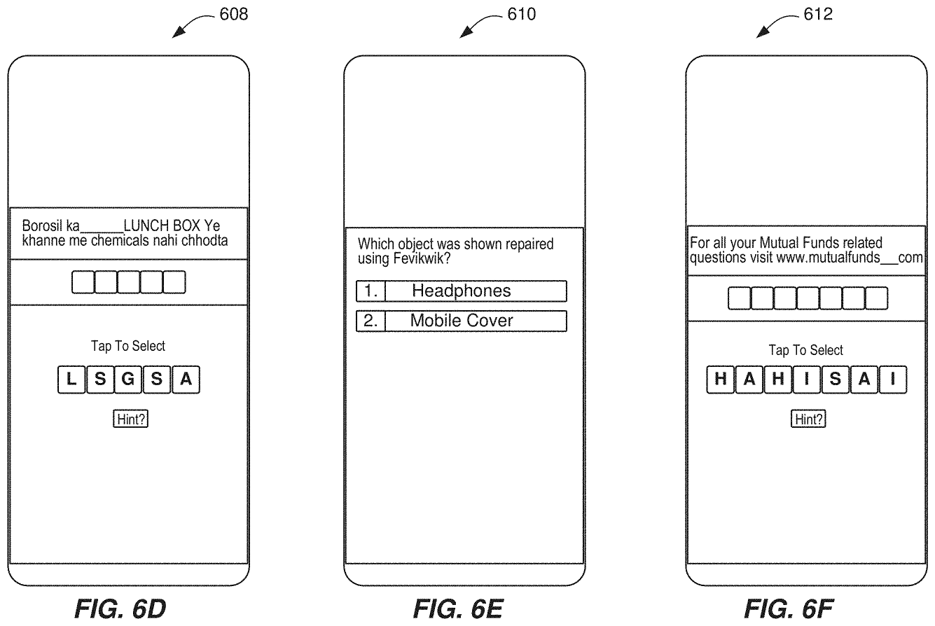

FIGS. 6A to 6E show various screen user interfaces for quiz formats. Of course, a conventional keyboard may also be displayed for the viewer to simply type in the word/answer or speak it using voice recognition. After completing the quiz and answering correctly, the viewer may continue with the previous action (e.g., playing a game or using an app) with an added benefit or may choose to visit the advertiser website. If the quiz is not answered correctly, the user engagement module may deliver and display another quiz or may allow the viewer to try again or may provide a hint or may allow the user to continue using the game or app or may block the user from going back to their game or app until they answer the quiz correctly. In another embodiment, the viewer can elect to play another video ad from the advertiser and answer another quiz resulting in additional awards, such as continuing use of the game or app, advancing to the next level in a game, or some benefit relevant to the activity the viewer was engaged in.

It is important to note the sequential nature of the interaction in the alternative embodiment. Specifically, 1) viewer elects to watch a video ad and take the quiz about the video ad or video message, 2) display then changes to the video ad and playback of the video ad executes, 3) the video ad completes and any trace of the video or the advertiser (brand, product, company, etc.) is removed from the display, and 4) the quiz about the ad is presented to the viewer. These phases of the user experience are presented sequentially, one after the other is completed. The viewer is not able to look at anything related to the ad when answering the quiz. This demonstrates that the viewer is able to recall the message from the ad without assistance or blatant copying (of a name, word, etc.) from text on the screen that the viewer can easily see. This sequential nature of the user experience distinguishes this advertising methodology from any existing ad viewing and user engagement mechanisms presently in use (e.g., products provided by companies such as Captcha).

The quiz itself is simple and easy to answer provided that the viewer paid minimal attention to the video ad. Recall of the message is required because no video frames or advertiser information is displayed when responding to the quiz. As such the viewer must recall, at least nominally, the message of the ad. And the advertiser has tangible proof that the viewer, in some capacity, saw and recalled the message in the video ad; the video ad was effective and that it carried out its purpose.

Over the long term, viewers are trained to recall or remember messages contained in video ads. The more often a viewer watches a video from the advertiser and reads the question/quiz, and answers it, the more familiar the viewer becomes with the advertiser, its products or services, and remembers the messages imparted by these videos. The user may be shown the same or a different quiz/question about the video ad each time they view the video ad. Overall, the present invention provides a more effective and form of advertising, marketing and consumer education.

How the video ads are displayed and on what types of devices, whether a smart watch, a large screen TV, or an autonomous vehicle display does not materially affect the main or alternative embodiments. Whether the video ads with quiz are displayed inside games or other apps, or during other times when a viewer is watching a screen, also does not materially affect the main or alternative embodiments. The user engagement module and other software modules still execute in the same manner, taking into consideration form factors, network bandwidth and connections, user interaction modes (e.g., mouse, touch screen, voice, etc.) on a mobile device, such as a smartphone or tablet or watch. It may also be implemented on larger displays where apps can execute, including big screen TVs, desktop displays, and other types of displays.

In some embodiments the video ad may be replaced by an alternative way to convey an advertisement or message to the consumer, such as a slide show, plain text, an image or a simple game. These are then followed by a quiz about the message that the viewer was shown. In yet other embodiments, the video ad is stopped before it is completed and a quiz or question about the video ad may be shown, and then the video ad may be continued and another quiz or question about the video ad may be shown.

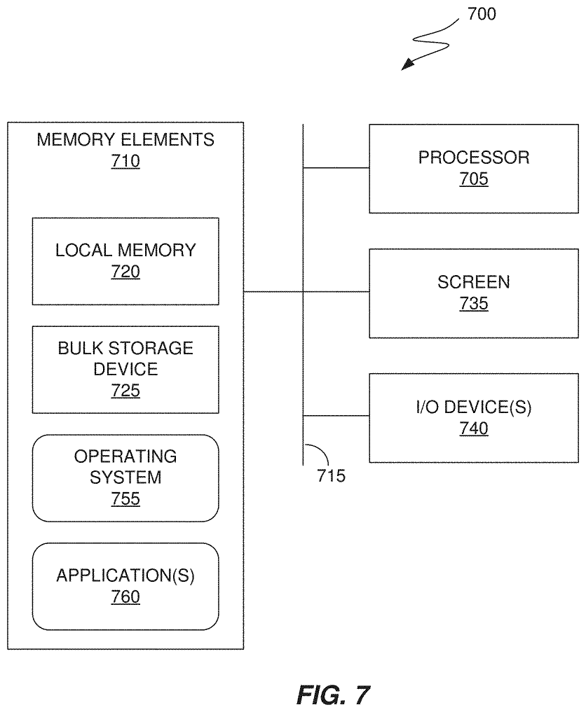

FIG. 7 is a block diagram of a data processing system 700 in accordance with one embodiment. System 700 may be used to implement any of a variety of systems and/or computing devices that include a processor and memory and that are capable of performing the operations described within this disclosure. It can be used to execute computer instructions to implement the logic flowcharts in FIGS. 4 and 5.

As pictured, system 700 includes at least one processor 705 coupled to memory elements 710 through a system bus 715 or other suitable circuitry such as an input/output (I/O) subsystem. System 700 stores program code within memory elements 710. Processor 705 executes the program code accessed from memory elements 710 via system bus 715. Memory elements 710 include one or more physical memory devices such as, for example, a local memory 720 and one or more bulk storage devices 725. Local memory 720 refers to random access memory (RAM) or other non-persistent memory device(s) generally used during actual execution of the program code. Bulk storage device 725 may be implemented as a hard disk drive (HDD), solid state drive (SSD), or other persistent data storage device. System 700 may also include one or more cache memories (not shown) that provide temporary storage of at least some program code in order to reduce the number of times program code must be retrieved from bulk storage device 725 during execution.

System 700 may be coupled to one or more I/O devices such as a screen 735 and one or more additional I/O device(s) 740. The I/O devices described herein may be coupled to system 700 either directly or through intervening I/O controllers. In one aspect, screen 735 may be implemented as a display device that is not touch sensitive. In another aspect, screen 735 may be implemented as a display device that is touch sensitive.

Examples of I/O device(s) 740 may include, but are not limited to, a universal remote control device, a keyboard, a mobile device, a pointing device, a controller, a camera, a speaker, and a microphone. In some cases, one or more of the I/O device(s) may be combined as in the case where a touch sensitive display device (e.g., a touchscreen) is used as screen 735. In that case, screen 735 may also implement a keyboard and a pointing device. Other examples of I/O devices 740 may include sensors. Exemplary sensors may include, but are not limited to, an accelerometer, a light sensor, touch screen sensors, one or more biometric sensors, a gyroscope, a compass, or the like.

I/O devices 740 may also include one or more network adapter(s). A network adapter is a communication circuit configured to establish wired and/or wireless communication links with other devices. The communication links may be established over a network or as peer-to-peer communication links. Accordingly, network adapters enable system 700 to become coupled to other systems, computer systems, remote printers, and/or remote storage devices, such as remote servers storing content. Examples of network adapter(s) may include, but are not limited to, modems, cable modems, Ethernet cards, wireless transceivers, whether short and/or long range wireless transceivers (e.g., cellular transceivers, 802.11x (Wi-Fi™) compatible transceivers, Bluetooth® compatible transceivers, and the like).

As pictured in FIG. 7, memory elements 710 may store an operating system 755 and one or more application(s) 760, such as applications for translating symbols and zero-amplitude time durations and symbol mapping tables. It may also store software for segmenting or breaking a message (to be transmitted) into pieces or segments that can be represented by symbols. In one aspect, operating system 755 and application(s) 760, being implemented in the form of executable program code, are executed by system 700 and, more particularly, by processor 705. As such, operating system 755 and application(s) 760 may be considered an integrated part of system 700. Operating system 755, application(s) 760, and any data items used, generated, and/or operated upon by system 700 are functional data structures that impart functionality when employed as part of system 700.

In one aspect, system 700 may be used to implement a computer, such as a personal computer, a server, or the like. Other examples of mobile computing devices may include, but are not limited to, a tablet computer, a mobile media device, a game console, a mobile internet device (MID), a laptop computer, a mobile appliance device, or the like.

System 700 may include fewer components than shown or additional components not illustrated in FIG. 7 depending upon the particular type of device that is implemented. In addition, the particular operating system and/or application(s) included may also vary according to device type as the types of network adapter(s) included. Further, one or more of the illustrative components may be incorporated into, or otherwise form a portion of, another component. For example, a processor may include at least some memory.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A method of implementing a video ad on a device and interacting with a viewer, the method comprising:
playing the video ad on a screen that can be seen by the viewer, wherein the video ad has a message and wherein the video ad is associated with a quiz that is about the message;
detecting that the video ad has stopped playing;
removing the video ad and any information about a company, a brand, a product, a service, or a message pertaining to the video ad;
displaying the quiz on the screen that can be seen by the viewer, wherein the quiz can be in one of a plurality of formats and wherein an answer to the quiz is indicative of whether the viewer remembers or recalls the message of the video ad;
detecting the answer to the quiz; and
processing the answer to determine whether the viewer responded to the quiz correctly or responded to the quiz incorrectly.

2. A method as recited in claim 1 further comprising:
providing the viewer with a benefit or reward if the answer is a correct response to the quiz.

3. A method as recited in claim 1 further comprising:
presenting a plurality of quizzes to the viewer wherein each quiz is about the message in the video ad and is intended to indicate whether the viewer received the message in the video ad.

4. A method as recited in claim 1 wherein the plurality of formats for the quizzes includes a re-arrangement of letters to form a word conveying the message, placing floating letters in an order for spelling out the message, popping multiple balloons with correct letters, speaking out letters or a whole phrase, moving the device to spell the letters, and choosing one answer from multiple choices.
